(19) United States
(12) Patent Application Publication
(10) Pub. No.: US 2008/0076013 A1
(43) Pub. Date: Mar. 27, 2008

(54) Conductive Structure for an Electrode Assembly of a Lithium Secondary Battery

(76) Inventor: Donald P. H. WU, Hsinchu County (TW)

Correspondence Address: Dr. BANGER SHIA, 102 Lindencrest Ct., Sugar Land, TX, 77479-5201, US

(21) Appl. No.: 11/459,999

(22) Filed: Jul. 26, 2006

(51) Int. Cl. H01M 2/26

(52) U.S. Cl. 429/94; 429/161; 429/211

(57) ABSTRACT

A conductive structure for an electrode assembly of a secondary battery comprises: a core disposed in a case, two lead terminals fixed at both ends of the core, an electrode assembly winding about the core, two clasping structures for enabling the electrode assembly to keep in electrical contact with the lead terminals, and two fixing nuts for fixing these components and the case. The electric connection between the positive lead, the negative lead and the lead terminals is achieved by clasping structures without the use of any welding operation. Therefore, the operation procedure of the present invention is effectively simplified, and the equipment cost is substantially reduced. In addition, the positive and negative leads are in a large area electrical contact with the collecting area, thus relatively reducing the internal resistance.

### BACKGROUND OF THE INVENTION

1. Field of the Invention

The present invention relates to a conductive structure for an electrode assembly of a lithium secondary battery, and more particularly to an electric power collecting and leading structure for an electrode assembly of a lithium secondary battery.

2. Description of the Prior Art

Referring to FIGS. 1 and 2, a spirally coiled electrode assembly 10 of a conventional lithium secondary battery disclosed by U.S. Pat. No. 5,849,431 comprises a web-like positive layer 11, a negative layer 12 and a separator layer 13 that are sequentially laminated to one another and are then wound about a core 14. One side of the positive layer 11 and the negative layer 12 are cut into rectangular teeth that serve as rectangular leads 111 and 131. The rectangular leads 111 and 131 are gathered together and then welded to the outer periphery of the disc-like conductive terminal 15. By such arrangements, the electric power can be exported out of the electrode assembly 10.

Referring to FIG. 3, a conventional lithium secondary battery disclosed by U.S. Pat. No. 6,447,946 is illustrated, which comprises a plurality of leads 111a and 131a welded to the end periphery of the electrode assembly 10a, and then the leads 111a and 131a are welded to the outer periphery of a conductive terminal 15a of the battery.

It is understood from the above description that no matter whether the leads are welded to or integral with the battery, eventually the leads and the conductive terminal will be electrically connected by welding. Note that the battery with a comparatively great number of leads does effectively reduce the internal resistance and reactance of the battery while improving the capacity thereof. However, these great number of leads also bring about the disadvantages of greater complexity in welding and manufacturing.

Therefore, the present invention is focusing on designing a battery structure whose electrode assembly is in direct electrical contact with the battery terminal without the use of welding operation.

### SUMMARY OF THE INVENTION

The primary objective of the present invention is to provide a conductive structure for an electrode assembly of a secondary battery. The electric connection between the positive lead, the negative lead and the lead terminals is achieved by clasping structures without the use of any welding operation. Therefore, the operation procedure of the present invention is effectively simplified, and the equipment cost is substantially reduced. In addition, the positive and negative leads are in a large area electrical contact with the collecting area, thus relatively reducing the internal resistance.

### BRIEF DESCRIPTION OF THE DRAWINGS

FIG. 1 is a perspective view of showing a conventional electrode assembly disclosed in U.S. Pat. No. 5,849,431;

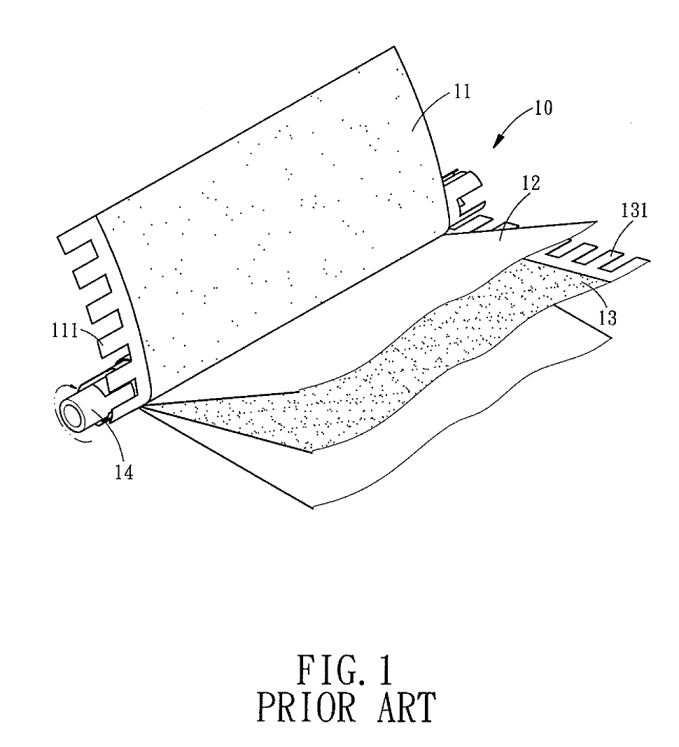

FIG. 2 is an illustrative view of showing the welding structure of the leads and the lead terminal of the conventional electrode assembly disclosed in U.S. Pat. No. 5,849,431;

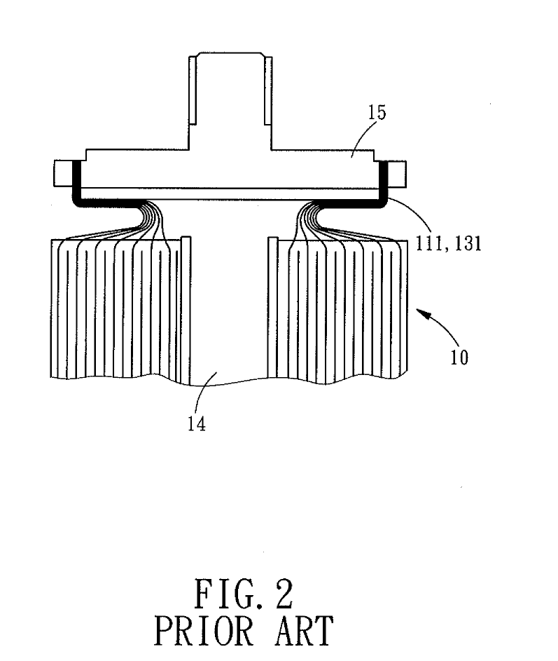

FIG. 3 is a cross sectional view of another conventional lithium battery;

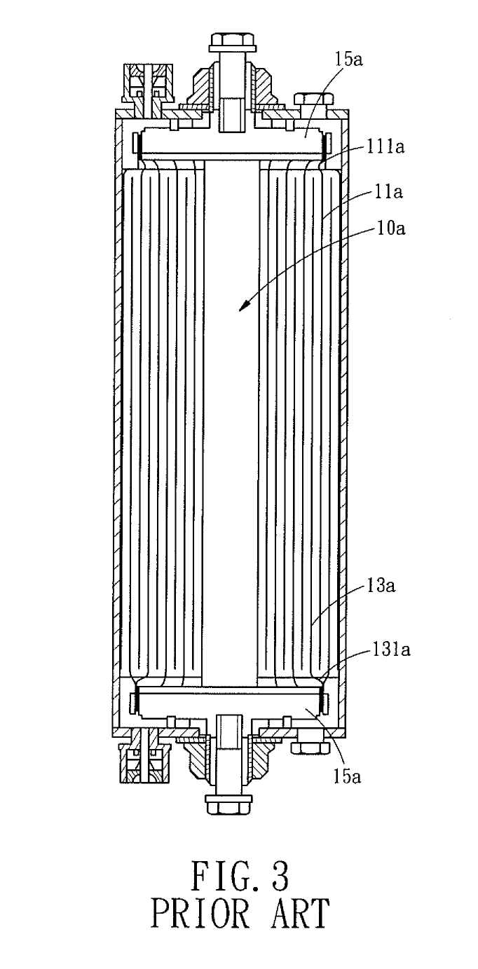

FIG. 4 is a perspective view of an electrode assembly in accordance with the present invention;

FIG. 5 is a perspective view in accordance with the present invention of showing the clasping structure and the electrode assembly before they are assembled together;

FIG. 6 shows that the clasping structure and the electrode assembly are assembled together;

FIG. 7 is a partially enlarged view in accordance with the present invention of showing the clasping structure and the electrode assembly after they are assembled together;

FIG. 8 is a cross sectional view in accordance with the present invention of showing the interior of the battery case;

FIG. 9 is a perspective view in accordance with a second embodiment of the present invention of showing the clasping structure and the integrally formed leads before they are assembled together;

FIG. 10 is a perspective view in accordance with the second embodiment of the present invention of showing the clasping structure and the integrally formed leads after they are assembled together;

FIG. 11 is a perspective view in accordance with a third embodiment of the present invention of showing the clasping structure and the integrally formed leads after they are assembled together;

FIG. 12 is a perspective view in accordance with a fourth embodiment of the present invention of showing the clasping structure and the electrode assembly after they are assembled together; and

FIG. 13 is a partially enlarged view in accordance with the fourth embodiment of the present invention of showing the clasping structure and the electrode assembly after they are assembled together.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

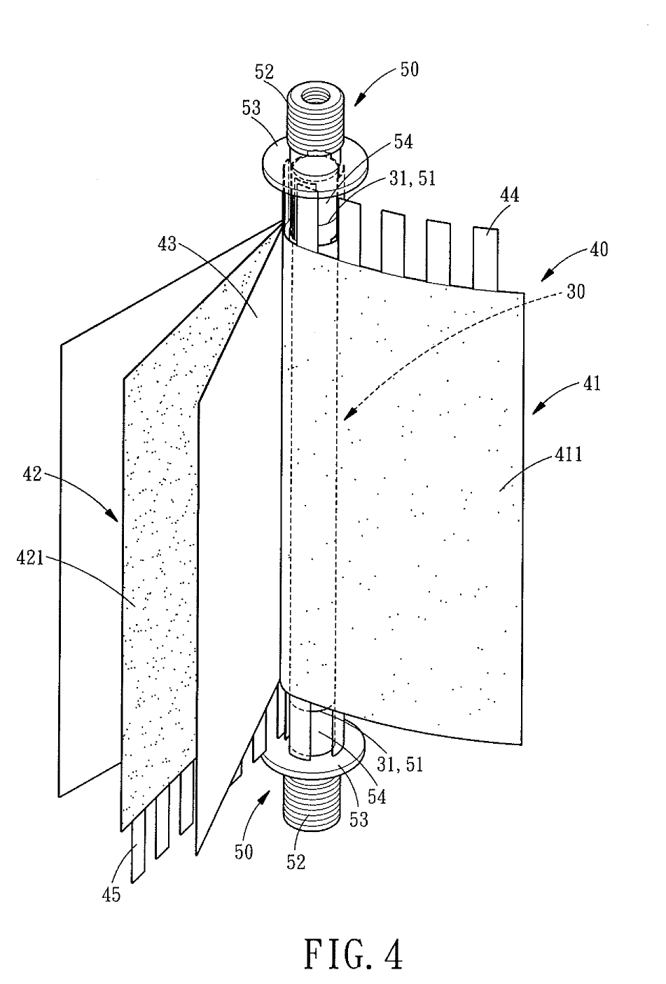

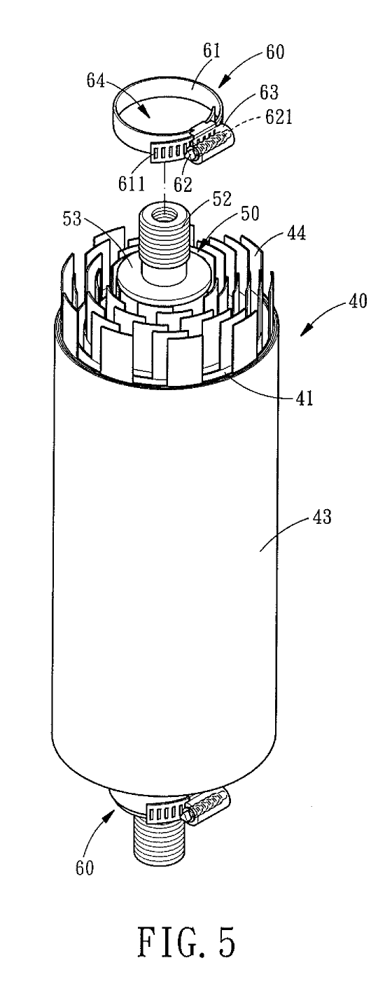

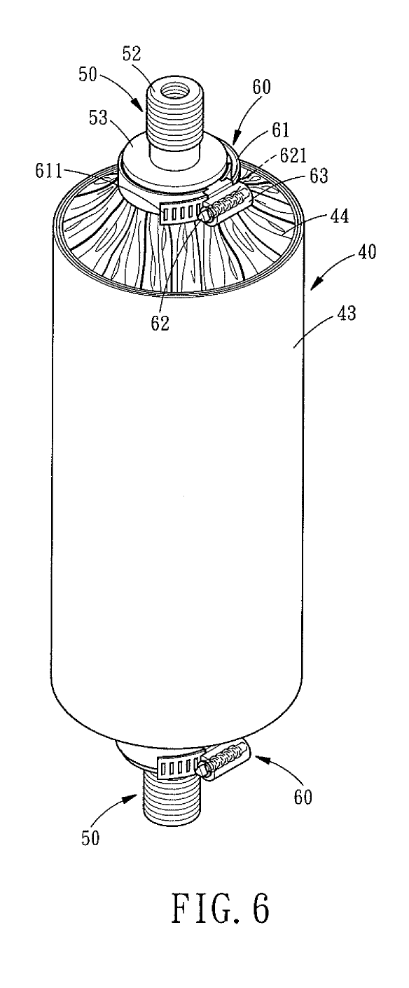

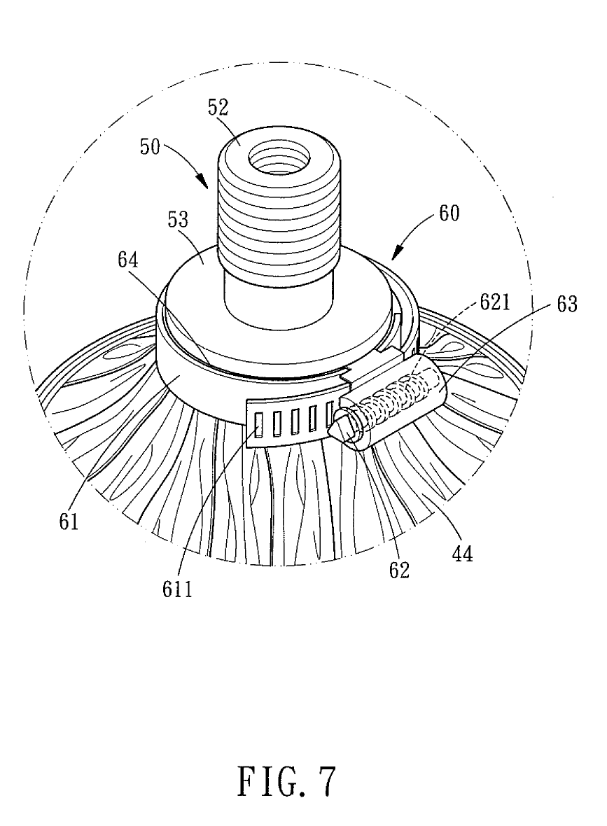

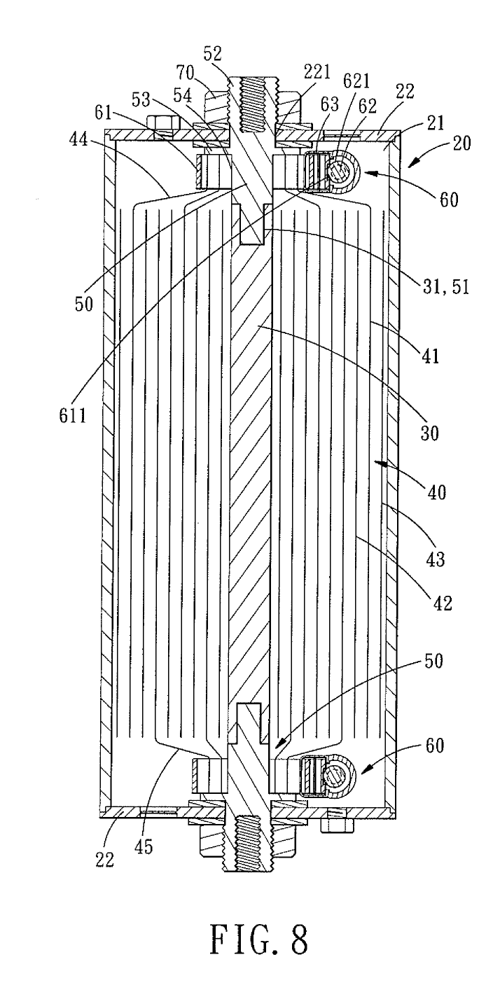

Referring to FIGS. 4-8, a conductive structure for an electrode assembly of a lithium secondary battery in accordance with the present invention is shown and comprises a core disposed in a case, two lead terminals fixed at both ends of the core, an electrode assembly winding about the core, at least one positive lead and at least one negative lead extending from two ends of the electrode assembly, two clasping structures for enabling the ends of the electrode assembly to keep in electrical contact with the lead terminals, and two fixing nuts for fixing these internal components and the case.

The case 20 is formed in either end thereof with an opening 21 in which the components of the battery are to be received, and each of the openings 21 are sealed with a cap 22. A port 221 is formed in the cap 22 for passage of the components of the battery.

The core 30 is an insulating structure disposed in the case 20 and is formed at either end thereof with a connecting portion 31, and the connecting portion 31 can be an inserting groove.

The electrode assembly 40 includes a positive layer 41, a negative layer 42 and at least one separating layer 43. The surfaces of the positive and negative electrode layers 41, 42 are coated with positive electrode material 411 and negative electrode material 421, respectively. The separating layer 43 is located between the positive and negative electrode layers 41, 42. At least one positive lead 44 is welded at a side of the positive layer 41, and at least one negative lead 45 is welded at another side thereof opposite the positive layer 41. The positive layer 41, the separating layer 43 and the negative layer 42 are superposed one upon another. After the electrode assembly 40 is formed by winding the positive layer 41, the separating layer 43 and the negative layer 42 about the core 30, the positive lead 44 and the negative lead 45 will protrude out of both ends of the electrode assembly 40.

Each of the lead terminals 50 is a conductive structure having a connecting end 51 formed at an end thereof. The connecting end 51 can be an inserting rod structure 511 to be connected to the connecting portion 31 of the core 30. Another end of the respective lead terminals 50 is formed with an output end 52 that can be a threaded rod structure. Each of the lead terminals 50 is particularly formed with a flange 53 and a collecting area 54 that are located between the connecting end 51 and the output end 52. The collecting area 54 is located correspondingly to the positive lead 44 or the negative lead 45. The flange 53 abuts against the cap 22 of the case 20.

Each of the clasping structures 60 includes a girdle 61, a rotary knob 62 and a casing 63. The rotary knob 62 is formed on its surfaces with a plurality of threads 621, and the girdle 61 is also formed on its surface with a plurality of threads 611. The rotary knob 62 and the girdle 61 are inserted through the casing 63, so that the girdle 61 defines a retaining hole 64, and the threads 621 are meshed with the threads 611. The retaining hole 64 can shrink or expand by rotating the rotary knob 62. The clasping structure 60 is mounted on the positive and negative leads 44, 45. By shrinking the retaining hole 64, the positive and negative leads 44, 45 will be maintained in a close electrical contact with the collecting area 54 of the lead terminals 50.

When the electrode assembly 40, the core 30, and the lead terminals 50 are assembled together by the clasping assemblies 60, and the output end 52 of the lead terminals 50 passes through the port 221 of the cap 22 until the flange 53 is pressed against the inner surface of the cap 22, the fixing nuts 70 will be screwed to the output end 52, enabling the respective components of the battery to be assembled in the case 20 more stably.

The clasping structure enables the lead to be maintained in direct electrical contact with the battery terminal without the use of welding operation. The electrode assembly of the present invention has a large area that is in electrical contact with the lead terminals, so that the secondary battery has an excellent capability to charge and discharge large currents.

For a better understanding of the present invention, its operation and function, reference should be made to FIGS. 4-7 again. The collecting area 54 is formed in the mid section of the lead terminals 50 and is located correspondingly to the positive and negative leads 44 and 45 of the electrode assembly 40. When electrically connecting the positive and negative leads 44 and 45 of the electrode assembly 40 to the lead terminals 50, the clasping structures 60 should be mounted onto the positive and negative leads 44, 45, initially. And then, the girdle 61 is driven to move within the casing 63 by rotating the rotary knob 62, and thus the retaining hole 64 starts to shrink. When the retaining hole 64 shrinks to such an extent that the girdle 61, the collecting area 54 and the positive lead 44 or the negative lead 45 are maintained in a close contact with one another, the positive lead 44 and the negative lead 45 are electrically connected to the lead terminals 50 without the use of welding.

It is to be noted that the electric connection between the positive lead 44, the negative lead 45 and the lead terminals 50 is achieved by clasping structures 60 without the use of any welding operation. Therefore, the operation procedure of the present invention is effectively simplified, and the equipment cost is substantially reduced. In addition, the positive and negative leads 44 and 45 are in a large area electrical contact with the collecting area, thus relatively reducing the internal resistance.

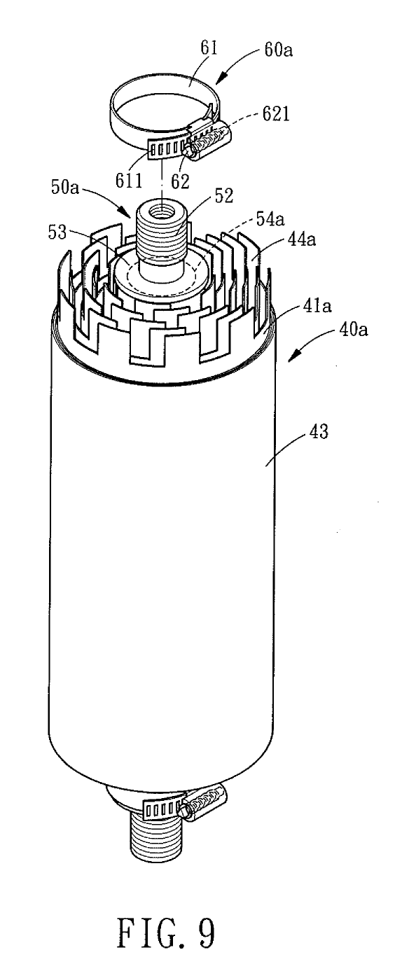

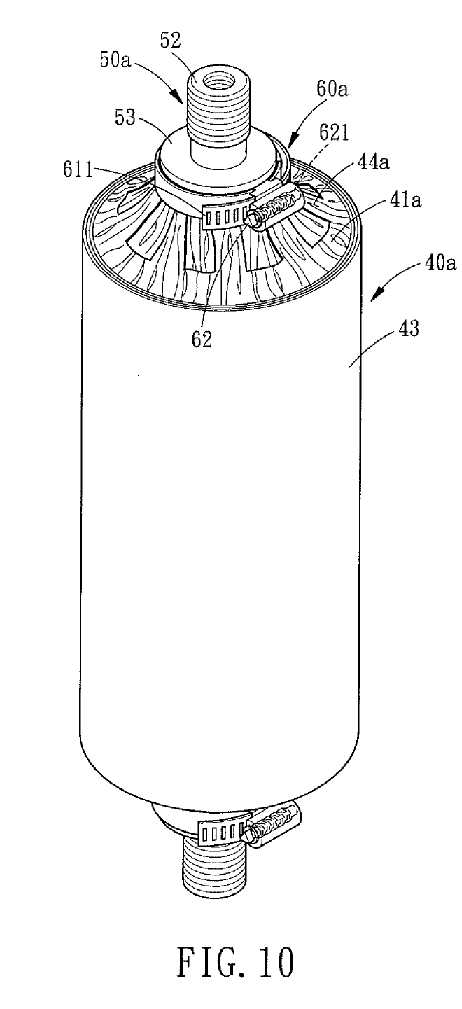

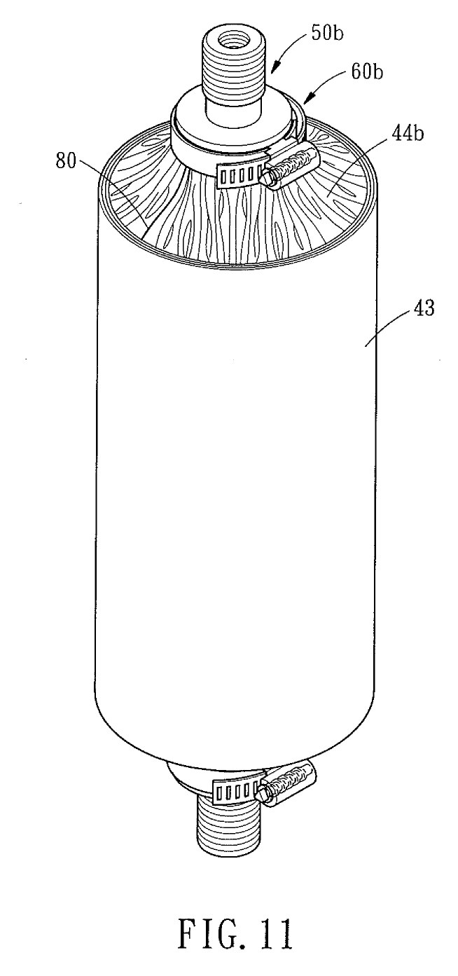

On the other hand, the positive lead or the negative lead mentioned in above embodiment has one end welded to the electrode assembly, as shown in FIGS. 9 and 10. The positive layer 41a or the negative layer of the electrode assembly 40a is provided with an uncoated area that is not coated with positive or negative electrode material. And then the uncoated area is cut into the positive leads 44a or the negative leads. After the integrally formed positive leads 44a or the negative leads are drawn together, the clasping structures 60a can also enable the positive and negative leads 44, 45 to be maintained in a close electrical contact with the collecting area 54 of the lead terminals 50. As shown in FIG. 11, the respective positive leads 44a or negative leads are located very close to each other and are separated by a narrow cutting seam 80. And the positive leads 44a or negative leads can also be maintained in a close electrical contact with the collecting area 54 of the lead terminals 50 by using the clasping structures 60b.

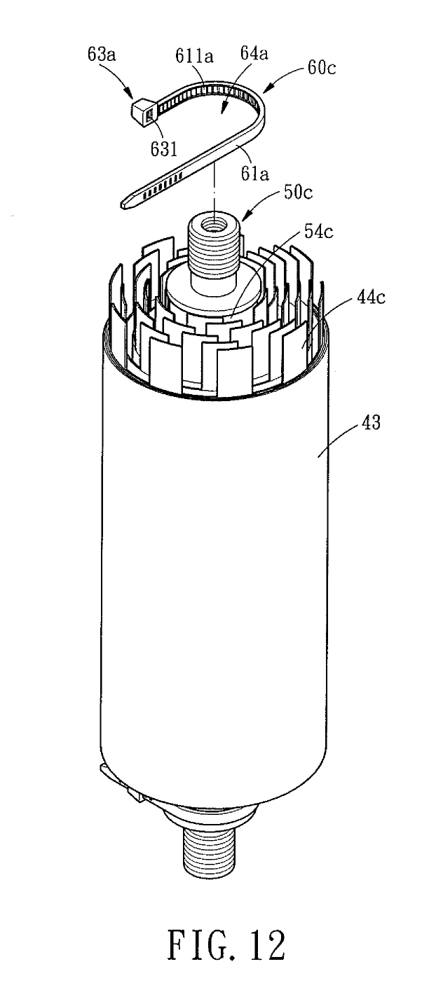

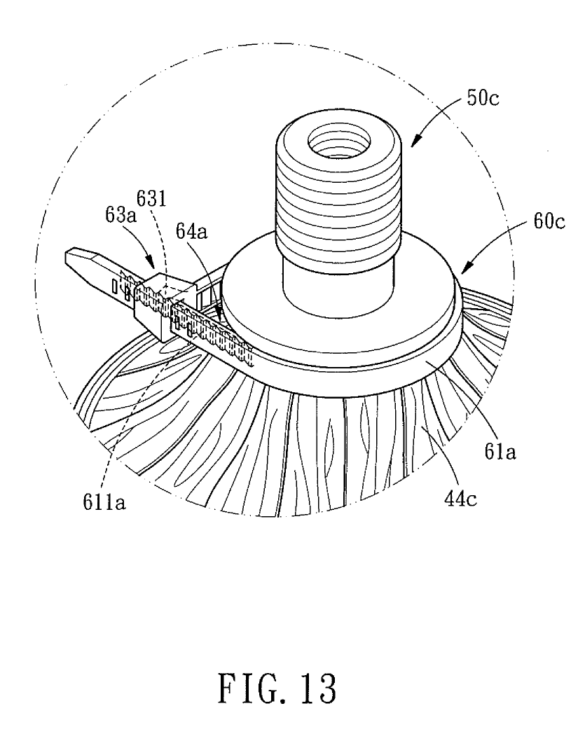

It is to be noted that the casing of the clasping structure 60c can be integral with the rotary knob, as shown in FIGS. 12 and 13. A locking portion 631 with a one-way tooth (pawl) for replacing the rotary knob is integrally formed in the casing 63a. When the girdle 61a is inserted through the casing 63a, the one-way tooth of the locking portion 631 will be engaged with the teeth 611a of the girdle 61a to stop backward movement of the girdle 61a, and thus the retaining hole 64a will shrink, enabling the positive and negative leads to be maintained in a close electrical contact with the collecting area 54c of the lead terminals 50c.

While we have shown and described various embodiments in accordance with the present invention, it is clear to those skilled in the art that further embodiments may be made without departing from the scope of the present invention.

What is claimed is:

1. A conductive structure for an electrode assembly of a lithium secondary battery comprising: a core disposed in a case, two lead terminals fixed at both ends of the core, an electrode assembly winding about the core, two clasping structures for enabling the electrode assembly to keep in electrical contact with the lead terminals, and two fixing nuts for fixing these components and the case; wherein
the electrode assembly includes a positive layer, a negative layer and at least one separating layer, surfaces of the positive and negative electrode layers are coated with positive electrode material and negative electrode material, respectively, the separating layer is located between the positive and negative electrode layers, an uncoated area is formed at a side of the positive layer for use as a positive lead area, and the negative layer is formed at another side thereof opposite the positive layer with an uncoated area for use as a negative lead area, the positive layer, the separating layer and the negative layer are superposed one upon another, and the positive and negative lead areas protrude out of both sides of an assembly consisted of the positive layer, the separating layer and the negative layer, after the electrode assembly is formed by winding the positive layer, the separating layer and the negative layer about the core, both ends of the electrode assembly will protrude out of the positive and negative lead areas;
each of the lead terminals is a conductive structure having a connecting end formed at an end thereof for connecting to a connecting portion of the core, another end of the respective lead terminals is formed with an output end, each of the lead terminals is particularly formed with a flange and a collecting area that are located between the connecting end and the output end, the collecting area is located correspondingly to the positive lead area or the negative lead area, the flange abuts against a cap of the case;
each of the clasping structures includes a girdle and a casing, a locking portion is disposed in the casing, the girdle is formed on its surface with a plurality of threads, a retaining hole will be formed after the girdle is inserted through the casing, and the locking portion will be engaged with the teeth of the girdle to stop backward movement of the girdle, and thus the retaining hole will shrink, the clasping structure is mounted on the positive lead and the negative lead, by shrinking the retaining hole, the positive and negative leads will be maintained in a close electrical contact with the collecting area of the lead terminals.

2. The conductive structure for an electrode assembly of a lithium secondary battery as claimed in claim 1, wherein the connecting portion of core is an inserting groove, and the connecting end of the lead terminals is an inserting rod to be inserted in the inserting groove.

3. The conductive structure for an electrode assembly of a lithium secondary battery as claimed in claim 1, wherein the girdle and a rotary knob are inserted through the casing of the clasping structures, the rotary knob is formed on its surfaces with a plurality of threads, the threads of the rotary knob are meshed with the threads of the girdle, the retaining hole can shrink or expand by rotating the rotary knob.

4. A conductive structure for an electrode assembly of a lithium secondary battery comprising: a core disposed in a case, two lead terminals fixed at both ends of the core, an electrode assembly winding about the core, two clasping structures for enabling the electrode assembly to keep in electrical contact with the lead terminals, and two fixing nuts for fixing these components and the case; wherein
the electrode assembly includes a positive layer, a negative layer and at least one separating layer, surfaces of the positive and negative electrode layers are coated with positive electrode material and negative electrode material, respectively, the separating layer is located between the positive and negative electrode layers, an uncoated area is formed at a side of the positive layer for use as a positive lead area, and the negative layer is formed at another side thereof opposite the positive layer with an uncoated area for use as a negative lead area, the positive layer, the separating layer and the negative layer are superposed one upon another, and the positive and negative lead areas protrude out of both sides of an assembly consisted of the positive layer, the separating layer and the negative layer, after the electrode assembly is formed by winding the positive layer, the separating layer and the negative layer about the core, both ends of the electrode assembly will protrude out of the positive and negative lead areas;
each of the lead terminals is a conductive structure having a connecting end formed at an end thereof for connecting to a connecting portion of the core, another end of the respective lead terminals is formed with an output end, each of the lead terminals is particularly formed with a flange and a collecting area that are located between the connecting end and the output end, the collecting area is located correspondingly to the positive lead area or the negative lead area, the flange abuts against a cap of the case;
each of the clasping structures includes a girdle, a rotary knob and a casing, the rotary knob is formed on its surfaces with a plurality of threads, and the girdle is also formed on its surface with a plurality of threads, a retaining hole will be formed after the rotary knob and the girdle are inserted through the casing, the threads of the rotary knob are meshed with the threads of the girdle, the retaining hole can shrink or expand by rotating the rotary knob, the clasping structure is mounted on the positive and negative leads, the positive and negative leads will be maintained in a close electrical contact with the collecting area of the lead terminals, when the retaining hole shrinks.
